(19) United States
(12) Patent Application Publication
(10) Pub. No.: US 2016/0056670 A1
(43) Pub. Date: Feb. 25, 2016

(54) System and Method for Generating Electric Energy and Torque using an Improved Magnet Positioning to Produce a Counter-Magnetic Field

(71) Applicant: Steven Wayne Ward, SR., Shepherd, TX (US)

(72) Inventor: Steven Wayne Ward, SR., Shepherd, TX (US)

(21) Appl. No.: 14/464,701

(22) Filed: Aug. 20, 2014

(51) Int. Cl. H02K 1/14; H02K 17/02; H02K 1/27

(52) U.S. Cl. CPC H02K 1/14; H02K 1/2706; H02K 17/02; Y10S 74/09; H02K 53/00

(57) ABSTRACT

This disclosure relates to a system and method for improvising motor efficiency using an improved magnet positioning and by applying an inductive load. A magnetic induction rotor assembly can comprise a core, a rotary device, a first winding, a second winding, and a magnet. The core can comprise a closed loop and two or more winding supports. The winding supports can be mounted to the inner portion of the closed loop. Each of the winding supports can comprise an orifice. The rotary device can comprise a rotor and a rod. The rod can pass between the winding supports. The first winding can be around a first side of one of the winding supports. The second winding can be on a second side of the other winding supports. The magnet can be mounted to the rod. The magnet can be within the orifices.

### BACKGROUND

This disclosure relates to a system and method for operating a rotor effectively by applying an inductive load.

Magnetic converters, or, devices that produce usable electrical and/or mechanical energy through the use of magnetic fields, or flux, are well known in the art. Some examples of magnetic converters include electric motors, electric generators, transformers, etc. A typical magnetic converter includes at least a pair of permanent magnets and a wire coil free to rotate between the magnets. The magnets are generally connected by a steel former and the wire coil is connected to lead wires using brushes. In a magnetic converter that is used to generate usable mechanical energy, the wire coil may be further connected to a drive shaft.

In a magnetic converter that is used to generate mechanical energy, e.g., an electric motor, a voltage potential is applied across the lead wires, thereby causing an electric current to flow through the coil. The flow of the electric current induces a magnetic field, or flux, around the coil. The coil's magnetic field repels and attracts the magnetic field generated by the permanent magnets, which, in turn, causes the wire coil to rotate. Accordingly, usable rotational mechanical energy, or torque, may be drawn from the drive shaft.

In a magnetic converter that is used to generate electrical energy, e.g., an electric generator, the wire coil is rotated in a magnetic field generated by the permanent magnets, thereby inducing a voltage in the wire coil. Accordingly, when the lead wires are connected to a load, e.g., a light bulb, electric current may be drawn from the coil. Consequently, once current begins to flow through the rotating wire coil, a force opposing the motion of the wire coil is also induced, thereby making the wire coil harder to turn. Thus, as is explained by the conservation of energy law, the more work that the converter does, the more work that must be put into its operation. In physical practice, the work put into the operation of the converter is produced by applying a greater mechanical driving force, or increased input torque, to the rotating wire coil.

Accordingly, it would be desirable to provide a magnetic converter for generating electrical energy in which the input torque applied to the magnetic converter need not be increased to maintain operation of the converter. Further, it would be desirable to provide a magnetic converter for generating electrical energy in which an input torque is not required to maintain operation of the converter, and, hence, usable output torque may be drawn from the converter. Advantageously, in such a scheme, the magnetic converter may be used to generate usable electrical and mechanical energy, thereby increasing an efficiency of the magnetic converter.

In U.S. patent Ser. No. 11/381,703, inventor Steven Ward, Sr. teaches using one or more magnets oriented to create a counter-magnetic field for generating an electric current. According to Ward, a counter magnetic field is the magnetic field induced around a coil when a direction of a polarity of the wire coil's magnetic field is counter to a direction of a polarity of the magnetic field existent between one or more magnets. However in the prior art, a counter-magnetic field is applied to a coil outside the windings, and the windings are each on a separate core.

As such it would be useful to have a system and method for generating electric energy and torque using an improved magnet positioning to produce a counter-magnetic field.

### SUMMARY

This disclosure relates to a system and method for improvising motor efficiency using an improved magnet positioning and by applying an inductive load. A magnetic induction rotor assembly can comprise a core, a rotary device, a first winding, a second winding, and a magnet. The core can comprise a closed loop and two or more winding supports. The winding supports can be mounted to the inner portion of the closed loop. Each of the winding supports can comprise an orifice. The rotary device can comprise a rotor and a rod. The rod can pass between the winding supports. The first winding can be around a first side of one of the winding supports. The first winding can comprise a first plurality of turns. The second winding can be on a second side of the other winding supports. The second winding can comprise a second plurality of turns. The magnet can be mounted to the rod. The magnet can be within the orifices. The magnet can have a north pole and a south pole. The poles can be oriented such that an imaginary line can run from the north pole to the south pole is orthogonal to the rod.

This disclosure also teaches a method for generating electric energy. The method can comprise the steps of rotating a magnet within orifices of a first winding support of a core and a second winding support of the core, and generating a current in a first winding around the first winding support and a second winding around the second winding support. The magnet can have a north pole and a south pole. The poles can be oriented such that an imaginary line can run from the north pole to the south pole is orthogonal to the rod. The first winding support and the second winding support each connected to a closed loop of the core.

### BRIEF DESCRIPTION OF THE DRAWINGS

FIG. 1 illustrates a magnetic induction rotor assembly.

FIG. 2 illustrates a sectional view of magnetic induction rotor assembly further comprising a magnet.

FIG. 3 illustrates a top view of a magnet.

FIG. 4 illustrates a graph showing the efficiency of applying an induced load to a rotor.

### DETAILED DESCRIPTION

Described herein is a system and method for operating a rotor effectively by applying an inductive load. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

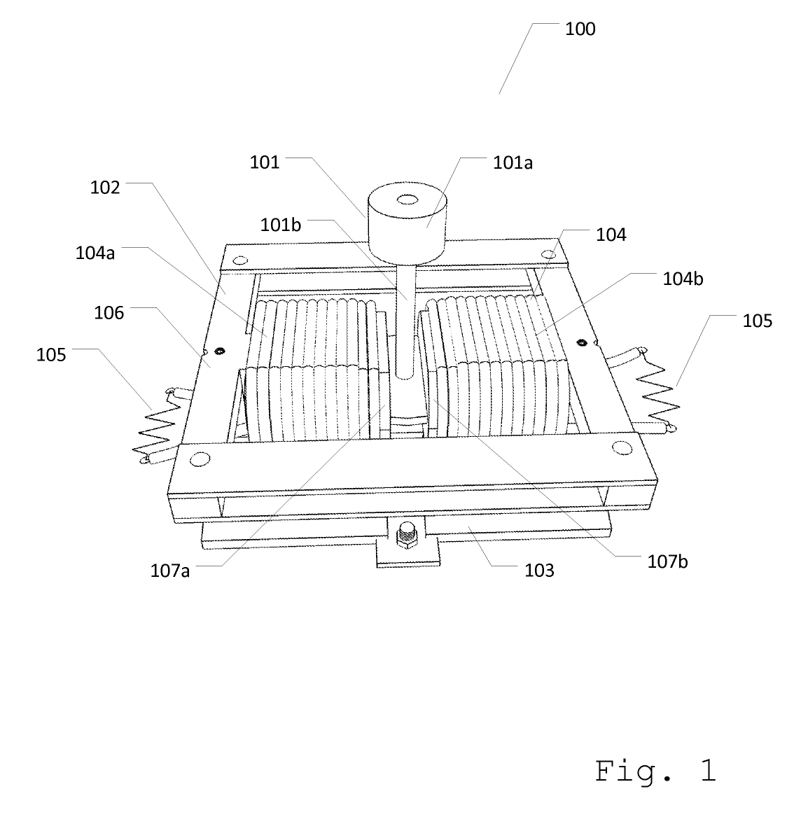

FIG. 1 illustrates a magnetic induction rotor assembly 100. Magnetic induction rotor assembly 100 can comprise a rotary device 101, and a core 102. In one embodiment, magnetic induction rotor assembly can further comprise a housing 103. In such embodiment, a portion of rotary device 101 and core 102 can mount a surface of housing 103. Rotary device 101 can convert electrical energy into a mechanical energy. Rotary device 101 can comprise a rotor 101a, and a drill rod 10 lb. Rotor 101a can rotate to produce a torque about the rotor's axis. Drill rod 101b can attach to rotor 101a. Therefore, the rotor 101a can transfer rotational movement produced by rotor 101a to drill rod 101b. Further, drill rod 101b can be the portion of rotary device 101 that mounts housing 103.

In one embodiment, core 102 can comprise a soft iron made of laminated sheets, such as silicon steel. This can ensure that magnetization is not retained within core 102. Furthermore, core 102 can concentrate the strength and increase the effect of magnetic fields produced by electric currents and permanent magnets. Core 102 can comprise a metallic closed loop 106 and two winding supports 107a and 107b or more mounted to the inner portion of metallic closed loop 106. In one embodiment, winding supports 107a and 107b can be mounted opposite each other such that a first windings 104a and a second winding 104b can be parallel to each other. In a preferred embodiment, a gap will exist between winding supports 107a and 107b. Such gap can allow for multiple hysteresis loops. Rod 101b can pass between winding supports 107a and 107b. As such, windings 104 can form magnetic poles when energized with electrical current. Additionally, windings 104 can be electrically insulated from one another. In one embodiment, windings 104 can be balanced, or have the same number of turns. In another embodiment, windings 104 can be unbalanced, thus first windings 104a can have different number of turns than second windings 104b. Further each winding 104 can be connected to a load 105. Load 105 can refer to any component that uses electric energy to operate.

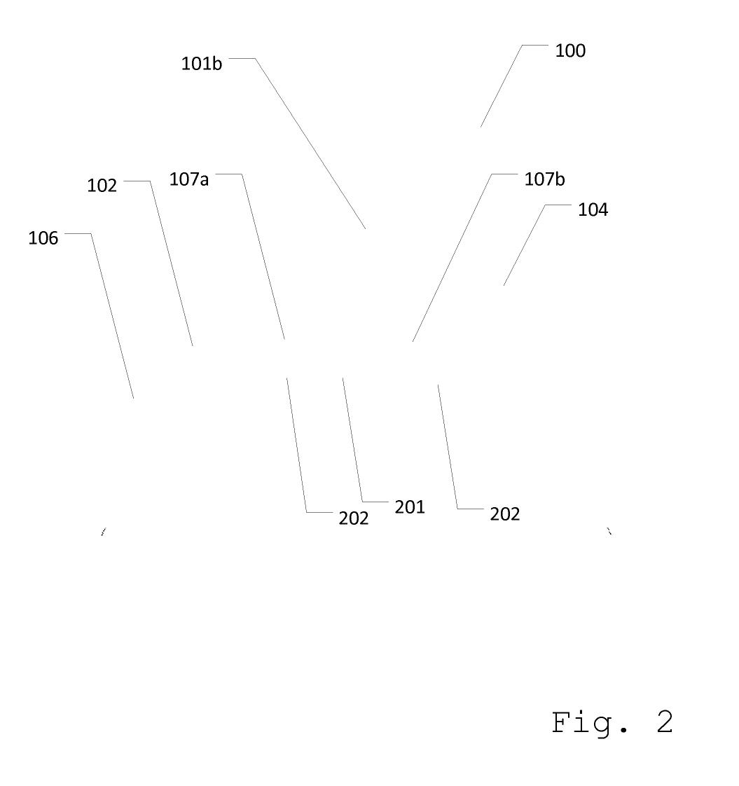

FIG. 2 illustrates a sectional view of magnetic induction rotor assembly 100 further comprising a magnet 201. Magnet 201 can be attached at the bottom end of drill rod 10 lb. In one embodiment, magnet 201 can be mounted within orifices 202 within winding supports 107a and 107b. In one embodiment, magnet 201 can be attached at the bottom end of drill rod 101. In this structure, once rotary device 101 is in operation, magnet 201 that is at the bottom of drill rod 10 lb can rotate within rotor's 101a axis. The rotation of magnet 201 can induce a current in windings 104. Therefore, as magnet 201 rotates through rotary device 101, current will be induced in windings 104. Such current can be delivered to load 105. In this structure, as frequency increases magnetic induction rotor assembly 100 can require less current to drive rotor 101a.

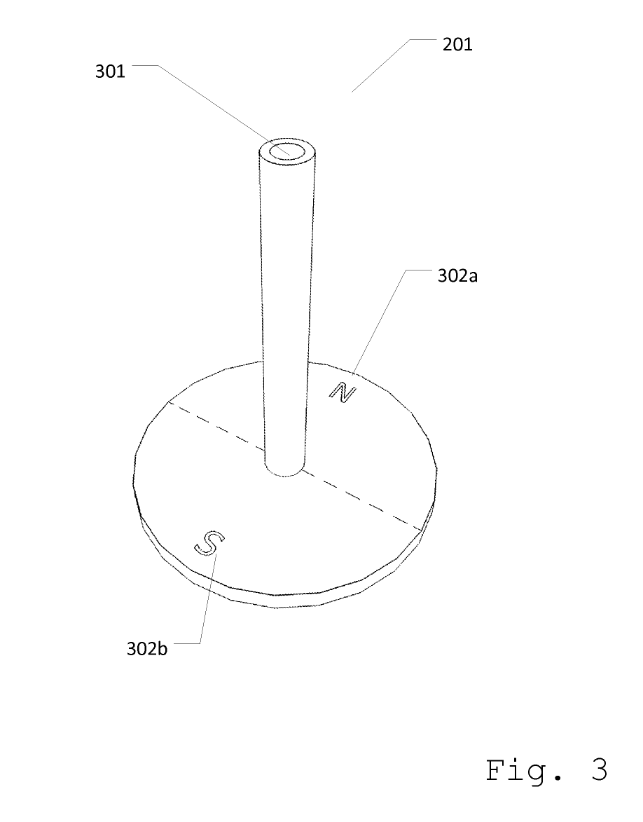

FIG. 3 illustrates a top view of magnet 201. Magnet 201 can substantially be circular in shape. In one embodiment, magnet 201 can comprise an orifice 301 at the center. In such embodiment, the bottom of drill rod 101b can be insertable to magnet 201 through orifice 301. A first half of magnet 201 can comprise a first pole 302a while a second half of magnet 201 can comprise a second pole 302b. As shown on FIG. 3, first pole can be a polar north, while second pole can be a polar south. The orientation of magnet 201 is such as to create counter-magnetic field, as described by Ward in U.S. patent Ser. No. 11/381,703, which we hereby incorporate by reference in its entirety. When magnet 201 is oriented such that first pole 302a is facing first winding support 107a and second pole 302b is facing second winding support 107b, there will be magnetic coupling between first winding support 107a and second winding support 107b. However, when magnet 201 is oriented such that first pole 302a and second pole 302b are each between second winding support and first winding support, each winding support becomes a keeper, and the magnetic field on each winding support 107a and 107b couples to itself. As such, magnetic field coupling between first winding 107a and 107b shuts off.

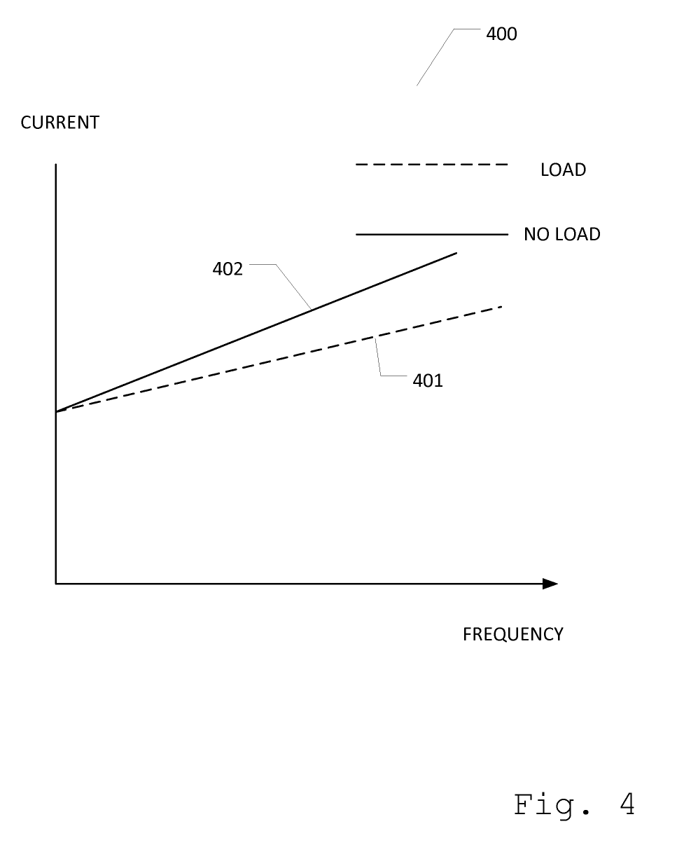

FIG. 4 illustrates a graph 400 showing the efficiency of applying an induced load 105 to a rotor 101a. Graph 400 can display a line graph for a winding connected to load line 401, and a winding disconnected from load line 402. In graph 400, x-axis can relate to a current required to turn rotor 101a while y-axis can relate to frequency of rotor 101a. Both winding connected to load line 401 and winding connected to load line 401 can start at the same point on x-axis, but winding disconnected from load line 402 can require more current to actuate rotor 101a than winding connected to load line 401. Thus as represented by graph 400, as frequency of rotor 101a increases, magnetic induction rotor assembly 100 can require less current to drive rotor 101a with a load than without a load. Therefore when load 105 is applied to winding 104, rotor 101a can rotate more efficiently.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A magnetic induction rotor assembly comprising
a core comprising a closed loop and two or more winding supports, said winding supports mounted to the inner portion of said closed loop, further wherein each of said winding supports comprising an orifice,
a rotary device comprising a rotor and a rod, said rod passes between said winding supports,
a first winding around a first side of one of said winding supports, said first winding comprising a first plurality of turns,
a second winding on a second side of other said winding supports, said second winding comprising a second plurality of turns,
a magnet mounted to said rod, said magnet within said orifices, said magnet having a first pole and a second pole, said first pole and said second pole oriented such that an imaginary line running from said first pole to said second pole is orthogonal to said rod.

2. The magnetic induction rotor assembly of claim 1 wherein each of said winding supports are mounted opposite each other such that said first windings and said second windings are parallel.

3. The magnetic induction rotor assembly of claim 1 wherein said first plurality of turns and said second plurality of turns are equal.

4. The magnetic induction rotor assembly of claim 1 wherein said first plurality of turns are different in number from said second plurality of turns.

5. The magnetic induction rotor assembly of claim 1 wherein each of said windings are connectable to a load.

6. The magnetic induction rotor assembly of claim 5 wherein less current is required to drive said rotor when connected to said load.

7. The magnetic induction rotor assembly of claim 1 wherein said magnet is a disc magnet

8. A method for generating electric energy comprising
rotating a magnet within orifices of a first winding support of a core and a second winding support of said core, said magnet having a first pole and a second pole, said first pole and said second pole oriented such that an imaginary line running from said first pole to said second pole is orthogonal to said rod; and
generating a current in a first winding around said first winding support and a second winding around said second winding support, said first winding support and said second winding support each connected to a closed loop of said core.

9. The method of claim 8 comprising the step of connecting a load to each of said windings such that less current is required to drive a rotor.

10. The method of claim 8 wherein each of said winding supports are mounted opposite each other such that said first windings and said second windings are parallel.

11. The method of claim 8 wherein said magnet is a disc magnet.

12. The method of claim 8 comprising the step of supplying power to one or more loads by connecting to said loads one of said first winding or said second winding.

13. The method of claim 8 wherein said first winding comprises more winds than said second winding.

14. The method of claim 8 wherein said first winding and said second winding have an equal number of windings.

15. The method of claim 8 further comprising the step magnetically coupling said first winding support with said second winding support by orienting said magnet such that a first pole is facing said first winding and a second pole is facing a second winding.

16. The method of claim 15 further comprising the step eliminating magnetic coupling between said first winding support and said second winding support by orienting said first pole and said second pole such that each are between both said first winding and said second winding.

17. The method of claim 8 further comprising the step eliminating magnetic coupling between said first winding support and said second winding support by orienting said first pole and said second pole such that each are between both said first winding and said second winding.
